(19) United States
(12) Patent Application Publication
(10) Pub. No.: US 2003/0162062 A1
(43) Pub. Date: Aug. 28, 2003

(54) Fuel cell apparatus with means for supplying two different hydrocarbon mixtures to a fuel converter for making hydrogen-enriched fluid

(76) Inventors: Guenter Hoenig, Ditzingen (DE); Ian Faye, Stuttgart (DE); Michael Nau, Dornhan/Aischfeld (DE); Rainer Saliger, Freiberg (DE)

Correspondence Address: STRIKER, STRIKER & STENBY, 103 East Neck Road, Huntington, NY, 11743, US

(21) Appl. No.: 10/302,088

(22) Filed: Nov. 22, 2002

(30) Foreign Application Priority Data
Nov. 24, 2001 (DE) 101 57 737.0

(51) Int. Cl. H01M 8/06; H01M 8/04

(52) U.S. Cl. 429/19; 429/20; 429/34

(57) ABSTRACT

The fuel cell apparatus includes a fuel cell (3) for converting chemical energy into electrical energy by burning a hydrogen-enriched liquid (7), a fuel-converting unit (22) for converting hydrocarbon-containing substances (11,12) to the hydrogen-enriched fluid (7), a first tank (1) for storing a first hydrocarbon-containing mixture (11) and optionally an internal combustion engine (4) which burns the hydrocarbon-containing substance. The production of the hydrogen-enriched fluid (7) is improved, especially in the cold starting operation stage, when the fuel cell apparatus includes a device for supplying a second hydrocarbon-containing mixture (12) at least to the fuel-converting unit (22) in certain operating stages.

### BACKGROUND OF THE INVENTION

1. Field of the Invention

The present invention relates to a fuel cell apparatus comprising a fuel cell or fuel cells, a fuel-converting unit for conversion of hydrocarbon-containing substances to a hydrogen-enriched fluid and a tank for a hydrocarbon-containing mixture.

2. Description of the Related Art

Fuel cell engineering has achieved ever-increasing importance, particularly in connection with future vehicle concepts. Fuel cells provide the possibility of directly converting chemical energy to electrical energy, which can subsequently be converted, for example, into mechanical energy by means of an electric motor. Besides that the electrical energy of the fuel cell apparatus can also be employed to provide different consumers, both for mobile applications as well as stationary applications.

In contrast to heat engines the efficiency of a fuel cell apparatus is not limited to the Carnot cycle efficiency. The currently preferred fuel cells consume hydrogen and oxygen and convert these elements into environmentally friendly products.

In many cases hydrogen-enriched fuel for the fuel cell apparatus is obtained by converting hydrocarbon substances, such as natural gas, benzene, diesel fuel or the like. For this purpose a suitable converter for conversion of the hydrocarbon-containing mixtures to a hydrogen-enriched fluid is used. Different conversion process can be used, for example auto-thermal reforming, vapor reforming, partial oxidation or the like.

Frequently in a conventional fuel cell apparatus so-called PEM fuel cells are used, in which especially carbon monoxide components in the hydrogen-enriched fluid react with a carbon monoxide coating of the catalytic electrode, so that the conversion of hydrogen at the electrode difficult or impossible. This CO coating is designated as a “poisoning” by those skilled in the art. For this reason a suitable fuel cell apparatus must produce a largely carbon monoxide-free, hydrogen-enriched fluid. Thus carbon monoxide components are nearly completely eliminated from the hydrogen-enriched fluid or fuel with the help of a suitable reactor.

Both the reactors and also the converter generally include a catalytic active coating for accelerating the respective reactions. In spite of the catalytic active coating these components, especially the converter, have operating temperatures of several hundred degrees Celsius, e.g. 500 to 1000° C.

A suitable heating device is known and used to achieve these operating temperatures, which heats the components of the fuel producing and fuel cell units, under cold starting conditions, among others. Disadvantageously comparatively long heat-up phases are required to achieve suitable operating temperatures. For example, currently reformers operating with conventional gasoline or diesel fuel require start-up times of several minutes. Corresponding waiting times cannot be pleasing currently to users of motor vehicles.

### SUMMARY OF THE INVENTION

It is an object of the present invention to provide a fuel cell apparatus with a fuel cell unit, a fuel converter for conversion of hydrocarbon-containing mixtures to a hydrogen-enriched fluid and a first tank for storage of a first hydrocarbon-containing mixture, which includes improved fuel producing means, especially an improved fuel converter, in comparison to the prior art, especially which significantly shortens the cold starting stage.

This object is attained by providing a means for supplying the fuel-converter with a second or another hydrocarbon-containing mixture in a predetermined operating stage, especially in a cold starting stage, in order to produce a hydrogen-enriched fuel having a comparatively greater volatility.

Additional embodiments with further advantageous features are described below and claimed in the appended dependent claims.

Accordingly the fuel cell apparatus according to the invention is characterized by means for supplying a different hydrocarbon-containing mixture than the first hydrocarbon-containing mixture to the converter in certain operating stages.

All commercially available fuels, such as gasoline or diesel fuel, are particularly suitable for use as the first hydrocarbon-containing mixture, in view of the existing infrastructure, simple handling and high operating efficiency.

According to the invention in certain operating stages, especially a cold starting stage, a second convertable hydrocarbon-containing mixture that is lighter than the first hydrocarbon-containing mixture is fed at least to the converter. Thus especially in the cold-starting stage, or when there is interference with normal operation or the like, the conversion or the production of a hydrogen-enriched fluid for the fuel cell or fuel cells is improved and/or the operating temperature required for the conversion is clearly reduced.

Consequently the starting time of the conversion can be considerably shortened, so that, for example, no troublesome waiting times occur on starting when the fuel cell apparatus according to the invention is used in a vehicle. Moreover according to the invention no exhaust gas with an unnecessarily high pollutant content is emitted during the starting stage, above all because of an insufficient operation of the converter.

Furthermore the material stresses and thus the wear on the materials can be advantageously reduced because of the lowered operating temperature of the converter in comparison to that of the prior art.

In a particularly advantageous embodiment of the fuel cell apparatus according to the invention the vapor pressure of the first hydrocarbon-containing mixture is less than the vapor pressure of the second hydrocarbon-containing mixture. The improvements of the conversion of the second hydrocarbon-containing mixture in relation to that of the first hydrocarbon-containing mixture are obtained with the help of this feature. For example, comparatively short chain hydrocarbons have a higher vapor pressure than comparatively long chain hydrocarbons. If necessary a separate vaporization or evaporation of the second hydrocarbon-containing mixture can be eliminated using the second mixture formed under standard liquid condition with a comparatively high vapor pressure. This leads to an improvement of the engineering work and a reduction of the construction expense.

Preferably at least one second tank or container for storing the second hydrocarbon-containing mixture is provided. For this purpose it is possible that the second hydrocarbon-containing mixture is generally available in sufficient amount, itself with strongly fluctuating consumption rate or the like. For example, the second hydrocarbon-containing mixture can be stored separately from the first hydrocarbon-containing mixture and/or can be supplied separately during different time intervals from the preparation site and consumed separately.

Alternatively or in combination the second hydrocarbon-containing mixture can be produced by means of a suitable production unit and the fuel converter can be supplied by it directly or by means of a second supply tank or container. Preferably the vehicle or the like has a production unit for making the second hydrocarbon-containing mixture.

In a special embodiment of the invention the second hydrocarbon-containing mixture is a component or part of the first hydrocarbon-containing mixture. Because of that it is possible to produce the second hydrocarbon-containing mixture from the first hydrocarbon-containing mixture. For example, other hydrocarbon-containing mixtures, such as the second hydrocarbon-containing mixture, can be produced by separation of higher and lower boiling or more or less volatile fractions from the first hydrocarbon-containing mixture. According to the invention the apparatus is designed so that the converter is supplied with e.g. the lighter or low-boiling fraction, if necessary by intermediate storage of this fraction in a second tank. In this way a separate fueling, for example of a vehicle, a stationary combined heat and power generating unit or the like, with two different hydrocarbon-containing mixtures is avoided. This reduces the expenses for operation of the apparatus.

Preferably a separate evaporator for vaporization of the first hydrocarbon-containing mixture and for producing a second and a third hydrocarbon-containing mixture is arranged in the fuel flow stream between the first tank and the converter. When the fuel-producing unit is this evaporator, which is arranged in the fuel flow stream upstream of the second tank, the separation or distillation of the first hydrocarbon-containing mixture to form the second comparatively more volatile hydrocarbon-containing mixture and to form a third comparatively less volatile hydrocarbon-containing mixture is possible.

An evaporator is comparatively easier and less expensive to construct than other units for producing hydrocarbon-containing mixtures, such as reactors or the like process technology units. Use of the evaporator leads to a comparatively economical fuel cell apparatus.

The evaporator preferably has at least one heating device for heating the first hydrocarbon-containing mixture to be evaporated. The evaporation or production of the second hydrocarbon-containing mixture is improved. This feature substantially increases its yield.

In a preferred embodiment of the invention the heating device is a heat exchanger. This guarantees that production of the heat energy for evaporation of the first hydrocarbon-containing mixture proceeds in an energy efficient manner. If necessary the heat of a heated fluid or the like can be advantageously used for the evaporization or vaporization in a preferable manner.

In a special further embodiment of the invention the fuel cell apparatus has at least one internal combustion engine, especially an Otto engine or Diesel motor, for combustion of the first, second or third hydrocarbon-containing mixture. For example, a motor vehicle, aircraft or boat can be driven with the help of the internal combustion engine. The fuel cell apparatus then will act as a combined heat and power source in the vehicle. Also the internal combustion engine can be used, especially for further use or preferably disposing of the third less volatile hydrocarbon-containing mixture.

Generally the internal combustion engine operates primarily by consuming the first hydrocarbon-containing mixture, so that use of the third comparatively heavy hydrocarbon-containing mixture does not lead to any disadvantages because of the comparatively small fraction in the total amount of the fuel. Particularly significant amounts of pollutant emissions or the like are not produced by operation of the vehicle in this manner.

Furthermore the fuel cell or fuel cell stack can be provided to supply different parts of the vehicle with electrical energy. Modern motor vehicles are equipped to an increasing extent with increasing numbers of electrical consumers, in order to perform additional functions for improving motor control, comfort and/or safety. High electrical power consumption thus occurs, which can be covered by a suitable fuel cell unit alone or in combination with the internal combustion engine or its so-called generator.

The fuel cell apparatus according to the invention can also make high power available even during idle of the internal combustion engine. Particularly the guaranteed power can be reliably provided for safety-relevant functions.

In a preferred manner a heat exchanger is connected with the converter, the fuel cell unit or fuel cell stack and/or the internal combustion engine to conduct heat from the heat exchange to those components. For example in an operating phase with excess heat produced by one or more parts of the fuel cell stack, e.g. the converter, the reactor for gas purification, the fuel cell or cells and/or the internal combustion engine, dissipated heat can be used to evaporate the first hydrocarbon-containing mixture. This exchange of heat for evaporation improves the total efficiency of the apparatus according to the invention.

In a preferred embodiment of the invention at least one condenser is provided for condensation of the second hydrocarbon-containing mixture. This guarantees that the gaseous ingredients of the second hydrocarbon-containing mixture are liquified. Thus this hydrocarbon-containing mixture has a comparatively small volume and high energy density. Accordingly the spatial requirements for handling and supply of the second hydrocarbon-containing mixture are reduced. If necessary special cooling devices, such as cooling ribs, cooling fans or the like are provided for improvement of the condensation.

Preferably the condenser is in the form of a second supply unit. Especially because of this structure the construction effort and expense for the fuel cell apparatus according to the invention is reduced.

At least one outlet element for outflow of the second hydrocarbon-containing mixture is arranged in an upper region of the first tank in a particularly preferred embodiment of the invention. The converter is preferably easily supplied with the second hydrocarbon-containing mixture present in different amounts and concentrations above the liquid level of the first hydrocarbon-containing mixture with the help of this suitable outlet element or elements. At the same time the first tank is formed as a production unit with the above-described features. Preferably the separate evaporator can be eliminated in certain applications, whereby the structural and processing expenses for producing the second more volatile hydrocarbon-containing mixture are reduced.

Generally at least one compressor is used for material transport of the hydrocarbon-containing mixture or the other operating materials. If necessary also transport of the individual or several mixtures or operating materials can occur by means of gravity.

In a preferred manner a compressor is arranged at least in the fluid flow stream of the flow element so that the second more volatile hydrocarbon-containing mixture is supplied to the compressor from the upper region of the first storage unit. For example a metering or amount regulation can be performed.

Furthermore the pressure in the first tank can be reduced by means of the compressor so that the yield of the second more volatile hydrocarbon-containing mixture is improved.

Simultaneously a pressure increase can be used for advantageous condensation of the second hydrocarbon-containing mixture if necessary by supplying the second more volatile hydrocarbon-containing mixture by means of the compressor or a special compressor supplied for that purpose. For that purpose a pressure regulating means, such as a throttle valve or the like, can be provided in an advantageous manner.

In a preferred embodiment of the invention in certain operating stages of the internal combustion engine the second more volatile hydrocarbon-containing mixture is supplied. For example, in a cold starting phase, in an idle state or other special operating stages, the internal combustion engine's operation can be improved by supplying it with the second hydrocarbon-containing mixture.

In an advantageous embodiment of the invention low pressure in the intake cycle of the internal combustion engine is used to reduce the pressure level in the first tank, so that the yield of the second hydrocarbon-containing mixture is increased in an advantageous manner. The operation of the internal combustion engine is thus improved in certain operation stages.

Generally the certain operation stages of the converter, in which it is supplied with the second hydrocarbon-containing mixture, can refer only to individual time intervals or also to special operating stages and continuous operation. The latter is, above all, realized when the internal combustion engine is combined in the fuel cell apparatus so that the internal combustion engine is powered by combustion of the first hydrocarbon-containing mixture and the converter is supplied with the second hydrocarbon-containing mixture. Generally the third hydrocarbon-containing mixture is supplied continuously or temporarily to the internal combustion engine.

Preferably at least one fluid storage unit or tank or container is provided for storage of a hydrogen-containing fluid. If necessary the hydrogen-containing fluid is the hydrogen-enriched fluid from the converter, from a fluid purifier, such as a shift unit, a CO cleaning unit or the like, and/or from exhaust gas or hydrogen-containing fluid flowing out of the fuel cell. An additional use of the chemical energy for one or more parts of the fuel cell apparatus independently of production of the suitable fluids, for example in the cold starting phase of the converter, can be realized with the help of a suitable storage means for the hydrogen-containing fluid.

Preferably at least one supply element for supply of the hydrogen-containing fluid is provided to the internal combustion engine. This guarantees that hydrogen-containing fluid is supplied to it in special operating stages of the internal combustion engine. Thus, operation is improved, for example, during the cold starting process for starting the internal combustion engine and a reduction of the idle speed during idling is possible.

Generally a reduction of the CO content of the fuel flow can be realized by means of the supply of the second more volatile hydrocarbon-containing mixture to the converter according to the invention, which facilitates improvement of the conversion process. For that reason the subsequent fluid purification stages provided as needed can be eliminated or at least reduced in size. For that reason the fuel cell apparatus according to the invention has an especially economical and comparatively compact means for producing the fuel for the fuel cell stack, especially when the so-called PEM fuel cells or the like are used.

Furthermore the size of the fluid reservoir, container or tank for storage of the hydrogen-containing fluid can be reduced and its pressure can be lowered, since earlier produced hydrogen-containing fluid is already frequently available for operation of the fuel cell or fuel cell stack during the cold starting stage and during load changes on the converter. Additional intermediate storage units, containers or the like for the hydrogen-containing fluids can be otherwise eliminated without disadvantageously effecting the cold starting behavior and the dynamics of the fuel cell unit, because of the fluids present in the provided pipes or ducts or the total volume.

### BRIEF DESCRIPTION OF THE DRAWING

The objects, features and advantages of the invention will now be described in more detail with the aid of the following description of the preferred embodiments, with reference to the accompanying figures in which:

FIG. 1 is a schematic block diagram of a first embodiment of the fuel cell apparatus according to the invention; and

FIG. 2 is a schematic block diagram of a second embodiment of the fuel cell apparatus according to the invention.

### DESCRIPTION OF THE PREFERRED EMBODIMENTS

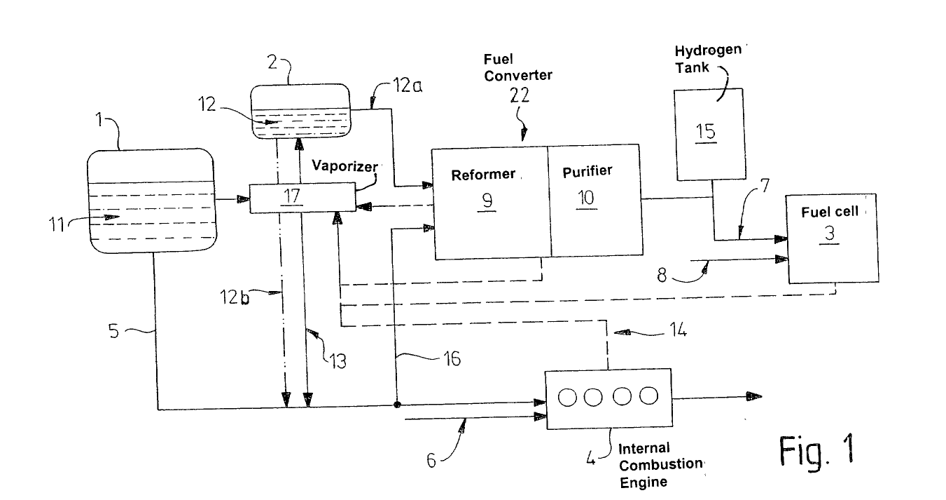

The embodiment of the fuel cell apparatus shown in FIG. 1 includes a tank 1, which contains a commercially available fuel, especially diesel fuel or gasoline 11, as well as a fuel cell stack 3 for producing electrical energy for electrical energy consumers. In vehicles with an electric drive motor, for example, the electrical motor and other components of the vehicle are supplied with electrical energy by means of the fuel cell stack 3. In the case of stationary fuel cell units electrical consumers for everyday life or the like can be supplied with electrical energy by means of the fuel cell stack 3.

The special embodiment of the invention shown in FIG. 1 particularly includes an internal combustion engine 4, especially for powering a vehicle. The internal combustion engine 4 is supplied in normal operation with gasoline 11 from tank 1 by means of engine fuel line 5. The required air supply for the internal combustion engine 4 is designated with 6 in FIG. 1.

The fuel cell stack 3 is operating with a hydrogen-enriched fuel 7 and with air 8. The hydrogen-enriched fuel 7 is, for example, produced by reforming gasoline 11 by means of a fuel converter 22, which comprises a reformer 9 with a purifier 10 arranged downstream from the reformer in the fuel flow direction. The conversion of the gasoline by means of the reformer 9 can, for example, occur by auto-thermal reforming, vapor reforming or partial oxidation. The purifier 10 is optional. The purifier 10 is a CO purification stage 10 with different shift units and/or selective oxidation units as needed for use with PEM fuel cells.

A hydrogen tank 15 is also provided. It permits supply of hydrogen-enriched fuel 7 to the fuel cell stack 3, even when the reformer 9 and the purifier 10 are still not working or not in order, for example during cold starting and/or breakdown/trouble stages, as well as during load changes. Preferably the hydrogen tank 15 is charged while the fuel cell stack 3 is only under a partial load. If necessary a separate refueling of the hydrogen tank 15 can be provided.

Generally gasoline 11 is supplied by means for gas line 16 to the reformer 9. In certain operation stages, such as the cold starting stage or the like, a gasoline component stream 12a is supplied to the reformer 9. The gasoline component stream 12a, is, like the gasoline 11, a hydrocarbon-containing mixture, which however has a higher vapor pressure than gasoline 11. That means that the gasoline components 12 are the more easily vaporized of the gasoline 11.

Generally another hydrocarbon-containing mixture, which is easy to reform in an advantageous manner or has a higher vapor pressure, especially easier than the currently obtainable gasoline 11, can also be used.

The gasoline components 12, which are produced by means of an evaporator 17 and stored in the second container or tank 2, are used as lighter more volatile components in order to reduce the supply work of the fuel cell apparatus. The evaporator 17 is optionally equipped with a heating device for improving the vaporization or distillation of the gasoline 11.

In the evaporator 17 a hydrocarbon-containing mixture designated gasoline residue 13 is also produced, that is preferably supplied to the internal combustion engine 4, e.g. via the main fuel supply line 5. The gasoline 11 is essentially unspoiled, so that no disadvantages arise from using this residue for operation of the internal combustion engine 4 and no relevant effects on emissions from the engine result. Generally the fraction of the gasoline residue 13 only amounts to 1/10 to at maximum ⅕.

In an especially preferred embodiment of the invention easily volatilized gasoline components 12, for example, can be supplied to the internal combustion engine 4 during a cold starting phase (see the second dashed line 12b according to FIG. 1). This can occur directly from the evaporator 17 and/or the tank 2.

The evaporator 17 is, above all, provided with dissipated heat 14 from the internal combustion engine 4, the reformer 9, the purifier 10 and/or the fuel cell stack 3 for improvement of the evaporation or distillation. The heat 14 is fed to the evaporator as shown by the dashed lines in FIG. 1.

For vaporization a certain amount of gasoline 11 is drawn from the tank 1 and is evaporated at a certain temperature, e.g. for gasoline at about 100° C. and for diesel fuel at about 250 to 350° C. The gasoline components condense in the tank 2 at lower temperatures, e.g. for benzene at about 60 to 70° C. and for diesel fuel at about 220 to 200° C.

The more volatile gasoline components 12 are supplied to the reformer 9, preferably so that they are available for cold start, and/or to the internal combustion engine. By supplying the gasoline components 12 to the reformer 9 its heating up stage is considerably shortened, since a reduced amount of energy is required to vaporize the materials to be reformed.

Generally continuous operation of the reformer 9 can be realized with the benzene components 12 from the tank 2 when the fuel cell stack 3 is combined with the internal combustion engine 4. This permits simplification or smaller dimensions for the entire fuel preparation means, i.e. the reformer 9 and the purifier 10, since the reformer temperature drops with the comparatively more volatile components 12 of the gasoline 11 to be reformed, and the reformation can be optimized. This leads to less material wear for the reformer 9. Similarly reduced concentrations of carbon monoxide, which damage a PEM fuel cell occur, whereby the purifier 10 can have reduced dimensions.

Generally it should be guaranteed by means of suitable control and/or monitoring means that the container or tank 2 is at least partially filled at the beginning of travel or at the start of operation. The tank 2 is preferably filled, when the fuel cell stack 3 is operated with or without the internal combustion engine 4.

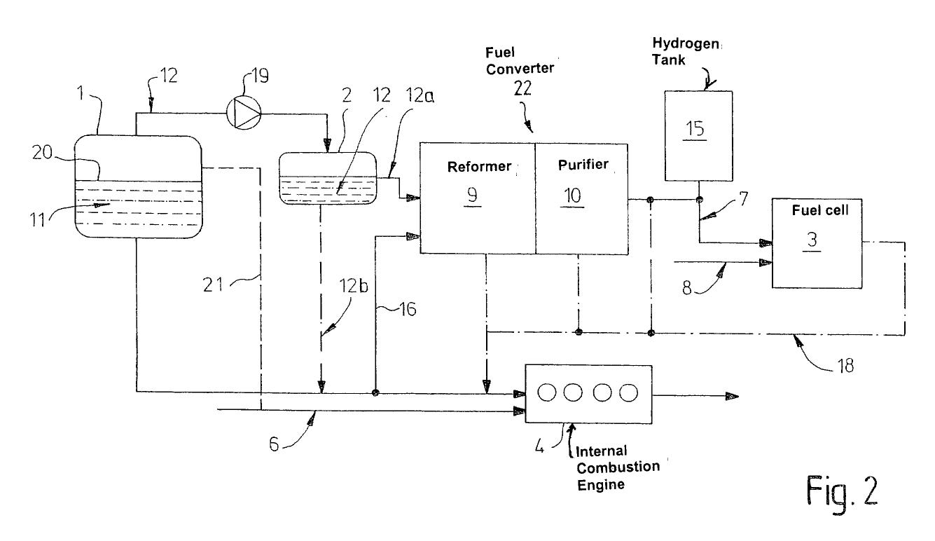

In FIG. 2 an additional embodiment of the invention is shown. This embodiment is comparable to the embodiment in FIG. 1. However the embodiment of FIG. 2 does not include a separate evaporator 17. The gasoline components 12 are drawn by means of the pump 19 from the tank 1. The corresponding pipe for drawing in the gasoline components 12 is arranged above a liquid level 20 of the gasoline 11. For this purpose it is guaranteed that only the gaseous vaporized easily volatilized gasoline components 12 of the gasoline are fed into the tank 2 from the tank 1.

In this embodiment the suction produced by the pump 19 acts to cause a certain lowering of the pressure level in the tank 1, so that the yield of easily volatilized gasoline components 12 increases. At the same time a certain increase in the pressure level in the tank 2 occurs, so that the condensation of the gasoline ingredients 12 in the tank 2 is improved.

According to FIG. 2 an optional low-pressure line 21 is provided for lowering the pressure level in the tank 1 during the intake cycle of the internal combustion engine 4. Also the yield of the gasoline components 12 can be improved according to the above-mentioned explanation. Other variants are conceivable for lowering the pressure level in the tank 1.

Moreover a comparatively low heating of the tank 1 can preferably be provided, if necessary, to improve the yield of the gasoline components 12. This can occur by means of supplying dissipated heat from the internal combustion engine 4, the reformer 9, the purification unit 10 and/or the fuel cell stack 3 (for example the dashed line 14 in FIG. 1).

Furthermore FIG. 2 shows that a hydrogen-containing fluid 18 can be supplied to the internal combustion engine 4 in certain operation stages. For example, the hydrogen-containing reformate is drawn from the reformer 9. Then the stream of hydrogen-containing partially purified hydrogen-containing fluid 7 from the purifier, which is largely free of CO and/or the hydrogen-containing residual gas from the fuel cell stack 3, can be supplied to the internal combustion engine 4. For example, pollutant emissions and cold starting can be improved by means of this feature.

The disclosure in German Patent Application 101 57 737.0 of Nov. 24, 2001 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a fuel cell apparatus, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A fuel cell apparatus comprising
at least one fuel cell (1) for converting chemical energy into electrical energy, said electrical energy being produced when fuel is oxidized and an oxidizing agent is reduced in said at least one fuel cell;
a fuel-converting unit (22) for converting hydrocarbon-containing substances to a hydrogen-enriched fluid (7),
a first tank (1) for storing a first hydrocarbon-containing mixture (11); and
means for supplying at least said fuel-converting unit (22) with a second hydrocarbon-containing mixture (12) in a predetermined operating stage.

2. The fuel cell apparatus as defined in claim 1, wherein said first hydrocarbon-containing mixture (11) has a vapor pressure less than a vapor pressure of said second hydrocarbon-containing mixture (12).

3. The fuel cell apparatus as defined in claim 1, further comprising at least one second tank (2) for storing said second hydrocarbon-containing mixture (12).

4. The fuel cell apparatus as defined in claim 1, wherein said second hydrocarbon-containing mixture (12) is a component of said first hydrocarbon-containing mixture (11).

5. The fuel cell apparatus as defined in claim 1, further comprising an evaporator (17) for vaporizing said first hydrocarbon-containing mixture (11) and for producing said second hydrocarbon-containing mixture (12) and a third hydrocarbon-containing mixture (13), and wherein said evaporator (17) is arranged in a fuel flow steam between said first tank (1) and said fuel-converting unit (22).

6. The fuel cell apparatus as defined in claim 5, wherein said evaporator (17) is arranged in said fuel flow stream upstream of at least one second tank (2) for said second hydrocarbon-containing mixture (12).

7. The fuel cell apparatus as defined in claim 1, wherein said evaporator (17) comprises at least one heating device for heating said first hydrocarbon-containing mixture (11) in order to evaporate said first hydrocarbon-containing mixture (11).

8. The fuel cell apparatus as defined in claim 7, wherein said at least one heating device is a heat exchanger.

9. The fuel cell apparatus as defined in claim 1, further comprising at least one internal combustion engine for burning said first hydrocarbon-containing mixture (11), said second hydrocarbon-containing mixture (12) or a third hydrocarbon-containing mixture (13).

10. The fuel cell apparatus as defined in claim 8, further comprising at least one internal combustion engine (4) for burning said first hydrocarbon-containing mixture (11), said second hydrocarbon-containing mixture (12) or a third hydrocarbon-containing mixture (13), and wherein said heat exchanger is connected with at least one of said fuel-converting unit (22), said at least one fuel cell (3) and said internal combustion engine (4) so as to conduct heat from said heat exchanger to said at least one of said fuel-converting unit (22), said at least one fuel cell (3) and said internal combustion engine (4).

11. The fuel cell apparatus as defined in claim 1, further comprising at least one condensation unit for condensing said second hydrocarbon-containing mixture (12).

12. The fuel cell apparatus as defined in claim 11, wherein said condensation unit is a second storage container.

13. The fuel cell apparatus as defined in claim 1, wherein the first tank (1) has at least one outlet element for outflow of the second hydrocarbon-containing fuel (12) arranged in an upper region thereof.

14. The fuel cell apparatus as defined in claim 13, wherein a compressor (19) is arranged in a fuel flow stream from said at least one outlet element in the first tank (1).

15. The fuel cell apparatus as defined in claim 1, further comprising a fuel reservoir (15) for storing a hydrogen-containing fuel liquid (7, 18).

16. The fuel cell apparatus as defined in claim 15, further comprising at least one internal combustion engine (4) for burning said first hydrocarbon-containing mixture (11), said second hydrocarbon-containing mixture (12) or a third hydrocarbon-containing mixture (13), and at least one feed means for feeding said hydrogen-containing fuel liquid (7, 18) to said at least one internal combustion engine (4).
